(19) United States
(12) Patent Application Publication
(10) Pub. No.: US 2012/0227035 A1
(43) Pub. Date: Sep. 6, 2012

(54) CROSS PLATFORM SERVICE NOTIFICATION

(75) Inventors: Oludare Victor Obasanjo, Renton, WA (US); Christopher Parker, Seattle, WA (US); Sean Gary Nordberg, Bellevue, WA (US); Agnieszka E. Girling, Woodinville, WA (US); Ankur Patel, Sammamish, WA (US); Miron Vranjes, Bellevue, WA (US)

(73) Assignee: Microsoft Corporation, Redmond, WA (US)

(21) Appl. No.: 13/039,483

(22) Filed: Mar. 3, 2011

(51) Int. Cl. G06F 9/445

(52) U.S. Cl. 717/176

(57) ABSTRACT

One or more techniques and/or systems are disclosed for notifying a user of availability of a service on a user's first platform (e.g., cell phone) where the user may have already used the service (or a variation thereof) on a second platform (e.g., laptop computer). In this manner, a user can be made aware of the availability of the service when using the first platform (e.g., cell phone) without having to search for (a version of) the service for the first platform, where the user may merely be aware of (a version of) the service for the second platform (e.g., laptop).

### BACKGROUND

In a computing environment, users can access applications, content and services from a variety of platforms. For example, a user may own a desktop computer, a laptop computer, a tablet device, a handheld gaming device, a smartphone, a console device connected to their television, and a web-connected television, among other things. The user may access the applications, content and services from any one or all of these devices. Further, applications, content and service may be provided from a variety of platforms, such as different marketplaces. For example, the user may download applications from an online app-store, a service provider website, or may access content from a desktop widget connected to the service provider. Often, an application available from or for one platform can be available from or for a second platform. For example, the user may use the same application (e.g., in different versions for use on different platforms) on their desktop and tablet devices.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A number of application developers, websites, and/or online brands can reach users from multiple software experiences across multiple platforms. It is common for an entity to have a website, multiple mobile applications, a social networking page, a micro-blogging account, widgets that may be present on a third-party site, and more, which can provide their customers multiple ways to engage and connect with one or more services provided by the entity. A key challenge for such an entity can be finding ways to reach a user/customer using all or some of these channels on which the customer is available. Currently, it is very cumbersome to cross-promote an availability of applications, content, or websites that a customer uses across multiple platforms, as it typically involves traditional advertising (e.g., placing online, or other media advertisements).

Accordingly, one or more techniques and/or systems are disclosed that may enable an entity to readily notify a user of availability of services (e.g., applications, websites, widgets, content, etc.) across multiple platforms (e.g., devices, operating systems, online marketplaces, etc.) that are already used by the user. For example, an entity creating a mobile application within a mobile device marketplace (e.g., app store) can also register an email domain from which the entity sends emails. In this example, when the entity sends the user an email, and the user is on a mobile device platform on which the entity has an application, the email application or website can also notify the user of the availability of the application for the mobile platform, if they do not already have the application installed. As another example, when the user goes to an application store, the application store can query an identity service for websites to which the user has connected and then notify the user of the availability of a corresponding application (e.g., where it appears that the user has not yet acquired said application for their platform (e.g., device)).

In one embodiment for notifying a user of availability of a service on a user's first platform, a request to identify if the user of the first platform is associated with the service can be received. Further, a determination can be made as to whether the service is installed on the first platform. Additionally, a response to the request can be sent that indicates that the service is available for installation on the first platform, if it is determined that the service is not installed on the first platform. In this manner, a user may automatically be made aware of the availability of an application, for example, for the user's device, for example.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for notifying a user of availability of a service on a user's first platform.

FIG. 2 is a flow diagram illustrating one embodiment where one or more portions of one or more techniques described herein may be implemented.

FIG. 3 is a flow diagram illustrating an example embodiment where one or more techniques described herein may be implemented.

FIG. 4 is a component diagram illustrating an exemplary system for notifying a user of availability of a service on a user's first platform.

FIG. 5 is a component diagram illustrating an example embodiment where one or more systems described herein may be implemented.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A method may be devised that provides for alerting a user of an application, for example, that the application (or a variation thereof) may be available on other platforms. For example, a user that downloads an application on their personal computer may be alerted that the application is also available for download to their handheld computer and/or smartphone. Alerts may be provided to the user when the user logs onto the alternate platform, for example, and/or may be provided when an email is received from a domain registered with an identify service for a particular platform and/or application. In this way, for example, the user may become more connected with services over a plurality of platforms without having to search, and the service providers can thus more fully connect with users over the plurality of platforms more readily.

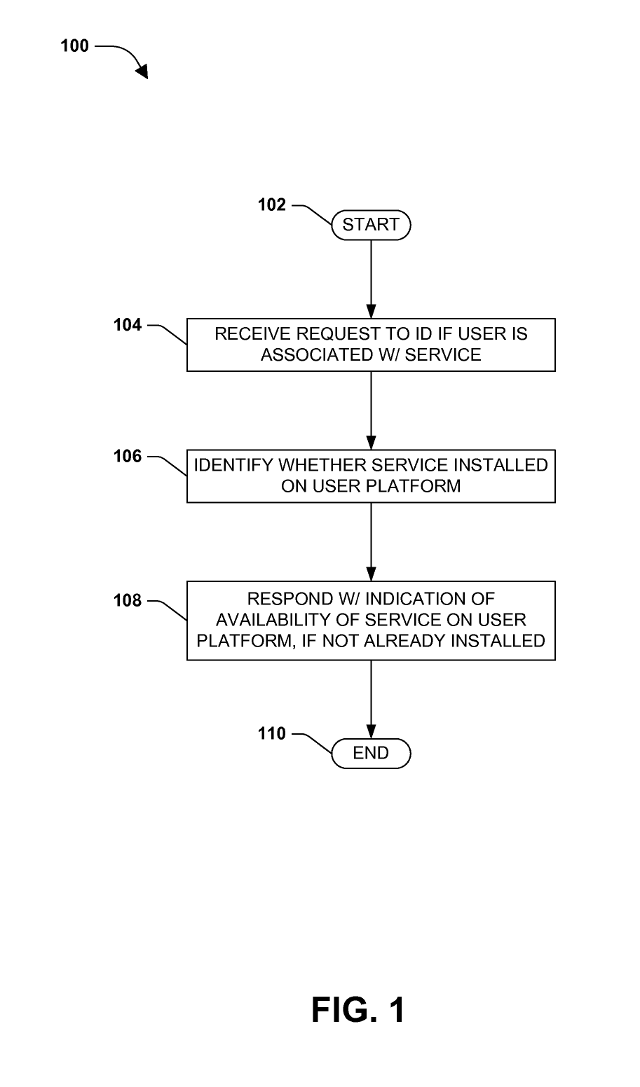

FIG. 1 is a flow diagram of an exemplary method 100 for notifying a user of availability of a service on a user's first platform. The exemplary method 100 begins at 102 and involves receiving a request to identify if the user of the first platform is associated with the service, at 104. For example, a service can comprise an application that may be linked to an online service and/or website, such as a social networking site application for a handheld device (e.g., smartphone, tablet, portable computer, etc.). As another example, the service can comprise a widget (e.g., a small application on the user's desktop linked to a web-service) that is linked to an online service and/or website, such as a weather website. As another example, the service may comprise a website, for example, that comprises web-apps, which may be executed in the user's browser. Other services and/or examples thereof are contemplated herein and the scope of the application and/or appended claims is thus not meant to be limited to these examples and/or to other examples provided below.

Further, a user's platform can comprise a particular device type, such as a handheld computer, smartphone, laptop/desktop computer, console device (e.g., gaming or media console linked to a television), for example, where respective devices may utilize different operating systems (OS) and/or applications to access the service. As an example, the first platform may comprise the user's smartphone, and a second platform may comprise the user's laptop computer. In this example, the first platform may utilize a first OS and the second platform may utilize a second OS, where the service operates differently and/or needs to be configured differently for the respective platforms.

Additionally, a user's platform may comprise an application store, such as an online store for viewing, searching, and downloading applications. For example, smartphones, handheld computing devices, laptop/desktop computers, consoles, etc. can respectively use different OSs, browsers, and/or other applications to access content that may be linked to an online service. For example, a first version of a web-linked application running in a first OS may not run in a second OS. In this example, a second version of the web-linked application may need to be downloaded from an app-store platform that comprises applications for the second OS. Therefore, in one embodiment, a first platform may comprise an app-store for applications particular to a first OS and a second platform may comprise an app-store for application particular to a second OS (e.g., a first smartphone app-store for a first phone OS, and a second smartphone app-store for a second phone OS).

In one embodiment, an identity service (e.g., on a remote server) may receive the request, for example, to find out if the user is using the service on another platform, or may be associated (e.g., registered) with the service from another platform (e.g., not the first platform). In this embodiment, the identity service may comprise a database that stores information about which service(s) the user may be associated with. For example, the user may have downloaded the service on a second platform, or may have registered to use a website associated with the service from a second platform. In this example, the identity service may comprise information that links the user to the service.

At 106 in the exemplary method 100, it is determined whether or not the service is installed (e.g., by the user) on the first platform. For example, the identity service may identify stored records comprising an identity for the user (e.g., a username, ID number, or some stored identification), such as records of services associated with the user. In one embodiment, the identity service can review records to determine whether the user is registered for a particular platform for the particular service, for example.

At 108, if the user is identified as not having the service installed on the first platform (e.g., a current platform used by the user), an indication that the service is available for installation on the first platform can be returned in response to the request. For example, if the request was sent by an online service linked to the application in question, the response can be sent from the identity service to the online service to let them know that the user has not downloaded the application on the platform in question. In this way, the online service may notify the user that they already have a relationship with the online service, such as from downloading the application to another platform, and that the user can also download the application to their current platform. In another embodiment, the response may be returned to the platform (e.g., device OS or app-store for OS), which may also notify the user of an availability of the service on their current platform, for example.

Having responded with an indication that the service is available on the user's first platform, the exemplary method 100 ends at 110.

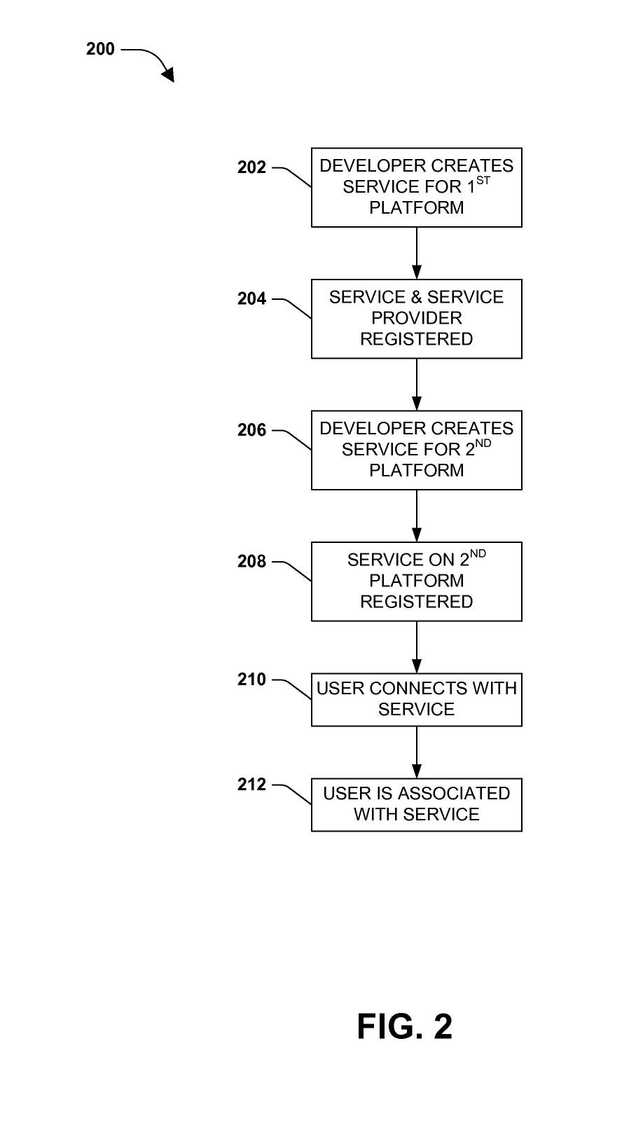

FIG. 2 is a flow diagram of one embodiment 200 where one or more portions of one or more techniques described herein may be implemented. At 202, a developer creates a service for a first platform. For example, a computer game developer may create a game that is compatible with one or more smartphones (e.g., comprising different operating systems), handheld devices (e.g., computers, portable gaming devices, tablets), console devices (e.g., set-top gaming consoles), computers, and/or browsers, for example. Typically, because more work may be needed to develop games that can run on a plurality of platforms, the developer may limit development to one or more of the most popular platforms (e.g., those comprising a greatest number of users of the type of service created by the developer), and/or may secure exclusive rights to development in selected platforms.

At 204 in the example embodiment 200, the service (e.g., application) and/or a provider of the service (e.g., an online presence associated with the application, such as a remote server linking to the service when running on a platform) can be registered. In one embodiment, the service and/or the service provider can be registered with an online identity service, which may be used to associate the service and/or service provider with users that have downloaded and/or linked with the service in some manner. For example, the online identity service may provide a service ID for the service, and can link the service ID with a user ID in a database managed by the online identity service, such as when a user downloads a service application to the user's platform.

In one embodiment, the service may be registered as available for use on one or more platforms. For example, an application for a connecting and interacting with an online social network service can be developed for one or more smartphone operating systems, one or more portable computing devices, one or more computer operating systems, and/or one or more console devices. In this example, the social networking application can be registered with the online identity service for the respective platforms. In one embodiment, the online identity service can provide an ID for the application for the respective platforms.

In one embodiment, the service may be registered as associated with a service online domain. For example, the provider of the online service may register an online domain (e.g., a web domain) that is associated with the service, and/or an online domain from which communication with a downloaded application originates. In another embodiment, the service may be registered as associated with a domain from which the service provider sends emails for the service. For example, the online service provider may send emails to users, and/or potential users, to let the users know about availability of an application for a platform.

At 206 in the example embodiment 200, the developer creates a second version of the service for a second platform. For example, the developer can create a first version of the service for the first platform, such as a laptop, and create a second version of the service for a second platform, such as a smartphone. At 208, the second version of the service for the second platform is registered, such as with the online identity service. For example, the ID for the online service provider of the service can be associated with the second version of the application in a database. In one embodiment, as described above, the developer may create a third (e.g., and fourth, etc.) version of the service (e.g., application) for a third (e.g., and fourth, etc.) platform, which may also be registered, such as with the online identity service.

At 210, a user connects with the service. Connecting with the service can comprise the user registering with the online service provider that provides the service, such as at a website for the online service provider, registering to receive emails from the online service provider, and/or downloading a version of the service to a platform (e.g., downloading an application or widget), for example. At 212, the user is associated with the service, such as via the online identity service. For example, the online identity service may register the user with the online service provider, and provide a user ID for the user. In one example, the user ID can be stored with an ID for the online service provider, and/or an ID for the version of the service associated with the user (e.g., in a database of the online identity service).

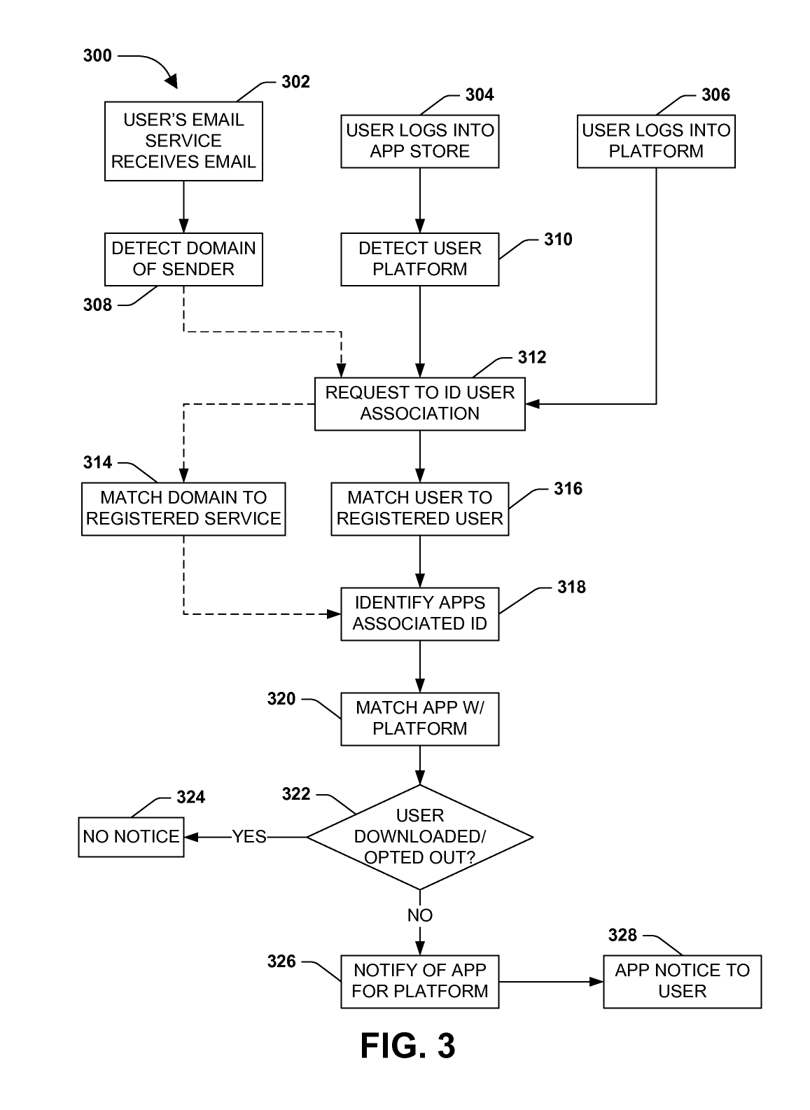

FIG. 3 is a flow diagram illustrating an example embodiment 300 where one or more techniques described herein may be implemented. In this example embodiment 300, a request to identify if a user of a first platform is associated with a service may be initiated by one or more of three user-related actions 302, 304, 306; although the initiation of the request is not limited to merely these three examples. At 302, an email service utilized by the user to receive emails (e.g., an email client on the user's device or an online email service) receives an email.

For example, an online service provider that registered their email domain with an online identity service may send an email to the user, which is associated with the service. In this example, the online service provider may send an email to the user about a new version of the service, and/or other news and updates related to the service. At 308, the email service can identify the domain of the sender, such as a domain from where the email was sent. At 312, the email service can send a request, such as to the online identity service, to identify if the user is associated with the service for the platform running the email service (e.g., is the user of the first platform associated with the service), such as using the email sender's domain.

In another embodiment, the request may be initiated by the user logging onto an online store, at 304. For example, the device comprising the first platform may comprise a browser and/or application that allows the user to access an app-store, where applications can be searched and downloaded for the first platform. In this embodiment, at 310, the first platform can be detected, such as by a service providing the online store, and/or by the browser or application providing access to the online store. For example, the first platform may comprise a console device, which the user utilizes to download and play games on their television. In this example, the console platform can be identified, and a request to identify if the user of the first platform is associated with the service can be sent, such as to the online identity service.

In another embodiment, the request may be initiated by the user logging into a platform, at 306. For example, the user may log into their desktop computer using a user identity. In this embodiment, the platform (e.g., or application resident on the platform) may send a request, such as to the online identity service, to identify if the user of the first platform is associated with the service. In another embodiment, the platform may send a request to identify if the user of the first platform is associated with any service, such as one that may be registered with the online identity service.

At 312, the request to identify if the user is associated with the service (e.g., or any service) is received, such as by the online identity service (e.g., or a remote server utilized by the online identity service). As described above, in one embodiment, the request may be initiated by the user logging onto the first platform (e.g., an online app-store, or onto the device platform); or initiated by the user receiving an email from a domain associated with the service. Further, as described above, in one embodiment, the request may be received from the email service receiving the email from the domain associated with the service; from the online service store comprising the service, where the online service store is connected with the first platform; and/or from an application resident on the first platform that provides the service.

In one embodiment, when the request is received from the email service, it may comprise a request to identify if the user is associated with the service on a second platform, where the second platform may comprise a device platform, and/or an online marketplace platform. For example, while the user may have been associated with the service through the online service provider (e.g., registering on the website for the online service provider), the user may or may not have downloaded or used the service on a platform. In this example, the online service provider may wish to identify if the user has used or downloaded the service on a second platform (e.g., other than the platform used to receive the email), such as to be able to notify the user that they can also download the service onto this other platform (e.g., if not already so installed). That is, for example, if the user downloaded the application on a laptop, they may not know it is also available for their smartphone.

In one embodiment, receiving the request to identify if the user of the first platform is associated with the service can comprise receiving a request from the online application store to identify if the user is associated with an application, widget, and/or website available through the application store. For example, an online marketplace, such as an application store, may provide a variety of service. Standalone applications, and/or applications that are linked to an online service provider can be downloaded to the user's device from the store, and con comprise games, utilities, productivity apps, entertainment apps, and much more. These applications may run on the device platform without an online connection, and/or may connect with the online service provider, such as for connecting to other users and/or to continually (e.g., or periodically) obtain and/or provide updated data. Further, widgets can comprise small applications that comprise a connection with an online service (e.g., weather, news, time, traffic, etc.) to provide updated content on the user's desktop, for example.

At 314, the detected domain (e.g., of email from 308) can be matched with a registered service, such as by the online identity service. In this example, if the domain is associated with an online service provider (e.g., or service), the ID for the service provider can be retrieved.

Alternately, at 316, an identity of the user that logged onto the online store (e.g., at 304), and/or the first platform (e.g., at 306) can be matched with a registered user, such as by the online identity service. For example, when the user logs in (to the store or device) they may provide a user identity, such as a username. In this example, the user identity can be compared against user identities stored in the database of the online identity service. If a match is found, for example, the user ID can be retrieved.

At 318, services (e.g., applications, widgets, websites) associated with the retrieved ID (e.g., registered service, provider, or user) can be identified, such as from the online identity service database. At 320, the identified service can be matched with one or more platforms for which the service is available. For example, the identity service may identify that the service is installed on a second platform but not a first platform (e.g., or on both the second and first platforms, or just the first platform).

In one embodiment, to identify whether the service is installed on the first platform (e.g. or a second, third, etc. platform), the database of the identity service may link the service provider ID and/or service application ID with one or more platforms for the service that are associated with the user ID (e.g., the user has downloaded and/or interacted with the service on an available platform).

At 322, if the user has already downloaded the service to a first platform, or the user opted out of downloading the service to the first platform (YES at 322), no notice may be sent in response to the request (e.g., or a response identifying that the user downloaded or opted out can be sent), at 324. For example, if the user has already downloaded the application, or if they were previously notified of the availability of the application for the first platform and they opted out, notifying them of the availability of the application may diminish the user experience.

However, at 322, if it is identified, such as by the identity service, that the user has not previously downloaded the application or opted out, and that the service is available for the first platform (NO at 322), a response may be returned that the service is available for the first platform, at 326. That is, for example, if the user has been identified as being associated with the service, such as by downloading the application on a second platform (e.g., smartphone), and the user has not opted out, and the application is available for the first platform, the response to the request can comprise a notification of availability of the application for the first platform.

At 328, the notice of availability can be provided to the user, such as by the platform, app-store, and/or the email service. In one embodiment, the user may decide whether to download or utilize the service. Further, in one embodiment, if the service is installed on the first platform after responding with the indication that the service is available for installation on the first platform, the service can be associated with the first platform. For example, the service may notify the online identity service that the user has downloaded the service for the first platform. In this example, the online identity service can update the database to indicate the association of the user with the service for the first platform.

Further, in one embodiment, the user may subsequently log onto a second platform. In this embodiment, a request may be received to identify if the user is associated with the service, and the response can comprise an indication that the service is available for installation on a second platform if the service is not installed on the second platform, as described above. For example, after receiving notification of the availability of the application for the user's laptop at work, and downloading the application, the user may subsequently log onto their smartphone. In this example, the user can now receive a notification that the application they downloaded to their laptop is also available for their smartphone.

A system may be devised for notifying a user of an availability of application, which they already use on one platform, for example, on a second platform utilized by the user. For example, the system may identify services utilized by the user on one or more devices owned by the user. In this example, if the user downloads an application on their personal computer they can be notified that the same application is available for use on their smartphone, such as when they log onto the smartphone. Notifications can be initiated when the user logs into an alternate platform, for example, or gets an email from a service with which the user may be registered, for example. In this manner, users may more readily find their favorite applications across a plurality of platforms (e.g., devices or online marketplaces), and the application service providers can be more fully connected to their customers.

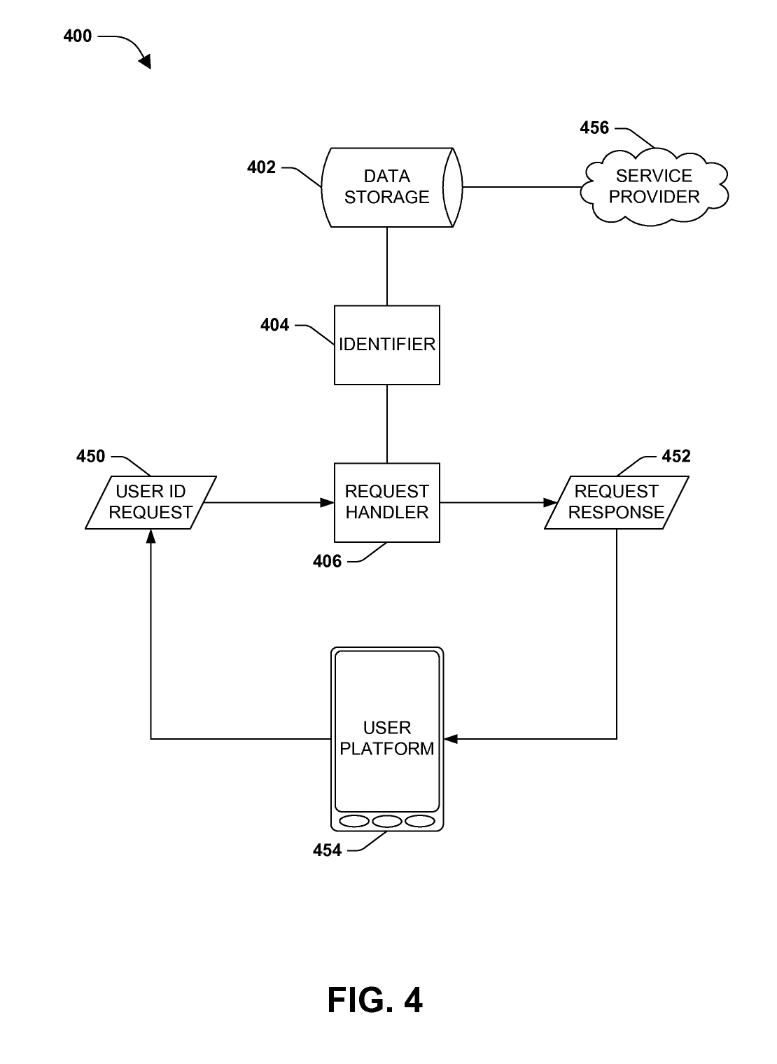

FIG. 4 is a component diagram of an exemplary system 400 for notifying an online user of availability of a service on a user's first platform. A data storage component 402 is configured to store information about one or more services associated with a registered service provider 456. An identification component 404 is operably coupled with the data storage component 402. The identification component 404 identifies whether the service from the registered service provider 456 is installed on the user's first platform 454, using the information on the data storage component 402.

A request handling component 406 is operably coupled with the identification component 404. The request handling component 406 receives a user ID request 450 that comprises a request to identify if the user of the first platform 454 is associated with the service. Further, the request handling component 406 responds to the request 450 with an indication 452 that the service is available for installation on the first platform 454 if the service is not already installed on the first platform 454. Although not illustrated, the system 400 (and 500) may comprise a processing unit, such as a microprocessor to process data for the system.

For example, the user may log onto the first platform 454 (e.g., a console device), and the first platform 454 (e.g., or application running on the first platform) can send a user ID request 450 to the request handling component 406 to find out if the user is associated with the service provider, such as on a second platform (e.g., a handheld computing device). In this example, the identification component 404 can compare user identification information with data stored in the data storage component 402 to identify if the user is associated with the service provider 456, that may have a registered identity on the data storage component 402. If the user is associated with the online service provider 456 (e.g., by downloading an application from the service provider 456 on the second platform), and the service is available for the first platform 454, the request handling component 406 can provide the response to the user, such as using the first platform, that the service is also available for the first platform.

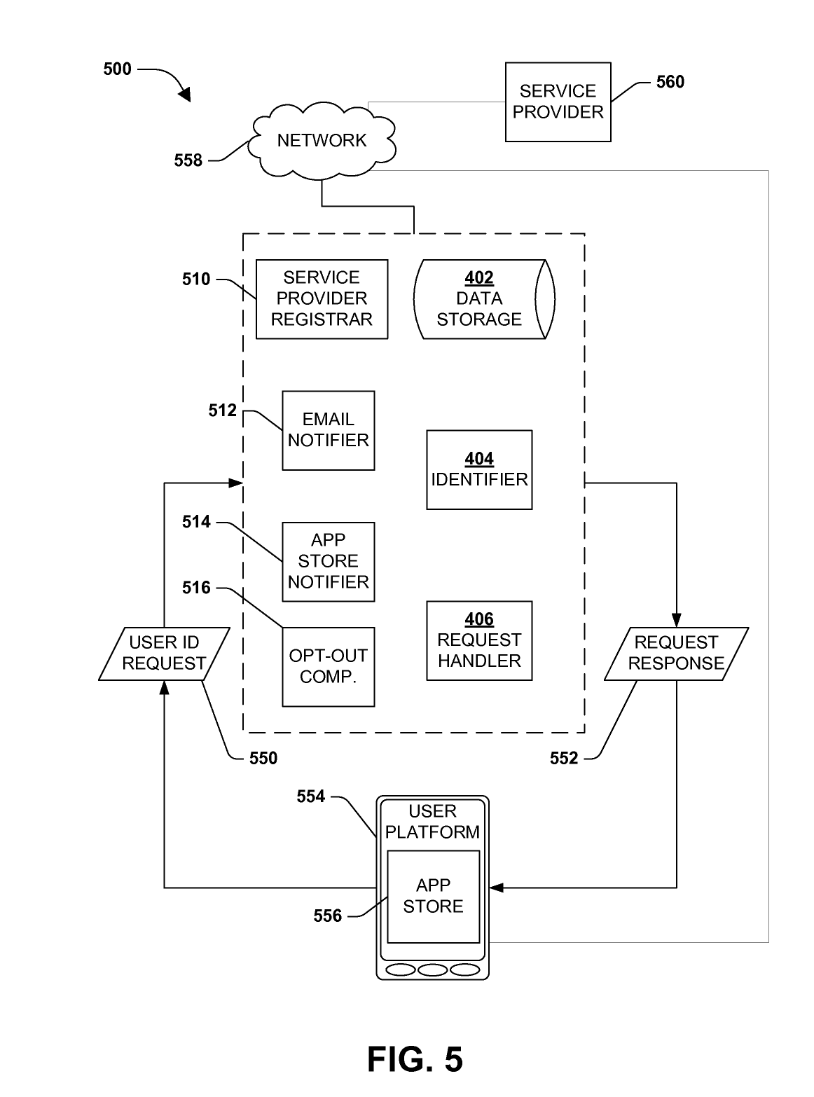

FIG. 5 is a component diagram illustrating an example embodiment 500 where one or more systems described herein may be implemented. In this example, an extension of FIG. 4 is provided and thus description of elements, components, etc. described with respect to FIG. 4 may not be repeated for simplicity. In this example embodiment 500, a first platform can comprise a device platform 554, such as a smartphone, portable computing device (e.g., handheld computer, handheld gaming device, etc.), laptop/desktop computer, console device, etc., or may comprise a marketplace platform 556, such as an app-store for one or more operating systems and/or devices, for example.

Further, a service, such as provided by a service provider 560 connected to the first platform over a network 558 (e.g., the Internet), can, for example, comprise: an application that is associated with a service provider 560, where the application has multi-platform functionality (e.g., is available for more than one platform); a website associated with the registered service provider (e.g., comprising web-apps); and/or a widget that can be connected from a plurality of platforms, such as to the online service provider 560 over the network 558.

In the example embodiment 500, a service provider registration component 510 can register the service provider 560 with a service provider ID and/or can register a service provided by the service provider with the service provider ID using an ID for the platform associated with the service. For example, the online service provider 560 can register with the service provider registration component 510 so that the service provider 560 is associated with a service provider ID in the data storage component 402. Further, the service provider 560 may register one or more services (e.g., applications, widgets) with the service provider registration component 510 so that the one or more services are associated with respective IDs and/or with the service provider ID, in the data storage component 402.

An email notification component 512 can identify a domain from which an email is sent to the user, such as from a domain registered by the service provider 560 to the user of the first platform 554. Further, the email notification component 512 can determine if the domain is associated with the registered service provider 560, such as by using the identification component 404. Additionally, the email notification component 512 can identify the registered service provider 560 associated with domain, if the domain is associated with the registered service provider 560. In one embodiment, the email notification component 512 may be operably coupled with an email service provider, such as an email client resident on the user device 554 or an online email service. In this embodiment, for example, the email service can provide the email domain to the email notification component 512.

An application store notification component 514 can determine if the user is associated with a service on a second platform, for example, upon receipt of a user ID request 550. Further, if the user is identified as being associated with a service on the second platform, the application store notification component 514 can identify a registered service provider (e.g., 560) associated with the service on the second platform. For example, the application store notification component 514 may use the identification component to identify associated platforms and/or services. The application store notification component 514 can also provide an indication that the service is available for installation on the first platform if the service is not installed on the first platform, such as by using the request handling component 406 to provide a notification response 552.

An opt-out component 516 can identify the user as having opted-out of a service if an opt-out request is received by the opt-out component 516. For example, the user of the first platform 554 may receive a notice (e.g., 552) that the service is available for downloading to the first platform. In this example, instead of downloading the application, the user may decide to opt-out of downloading the application, thereby no longer wishing to receive notifications of the availability of the application. In this embodiment, for example, when the opt-out component 516 receives the opt-out request for the user, for the application on the first platform 554, an indication of the opt-out can be stored in the data storage component 402. In this way, for example, when the user later logs onto the first platform, they may not be notified of the availability of the application for the first platform.

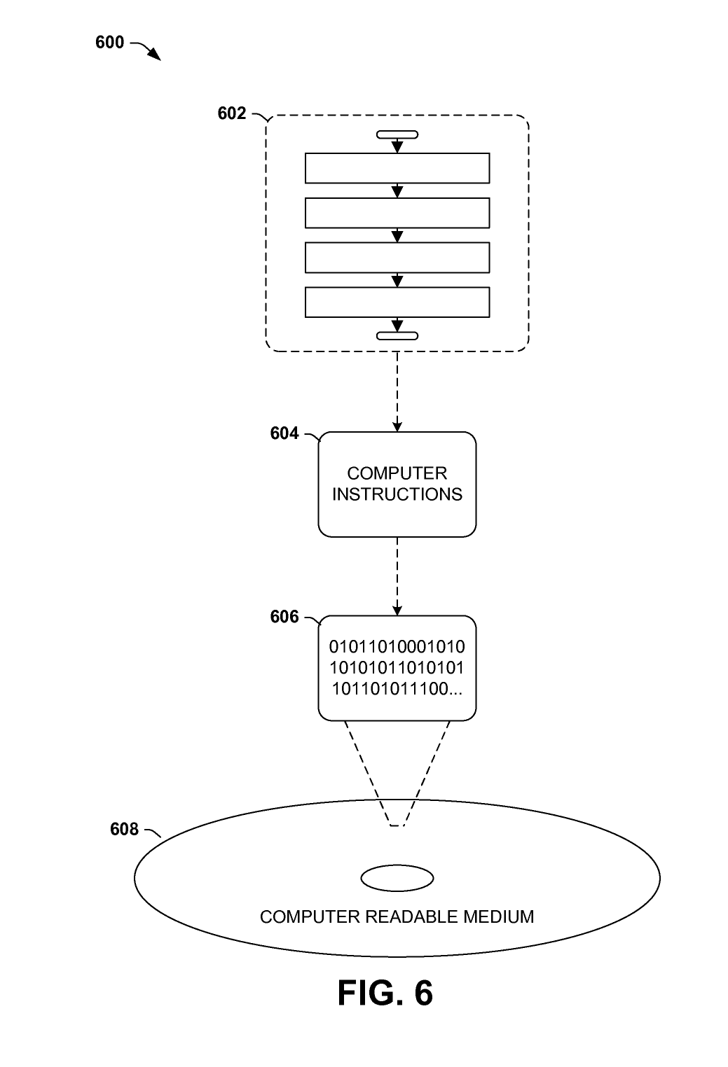

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 608 (e.g., a CD-R, DVD-R, or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as at least some of the exemplary method 100 of FIG. 1, for example. In another such embodiment, the processor-executable instructions 604 may be configured to implement a system, such as at least some of the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

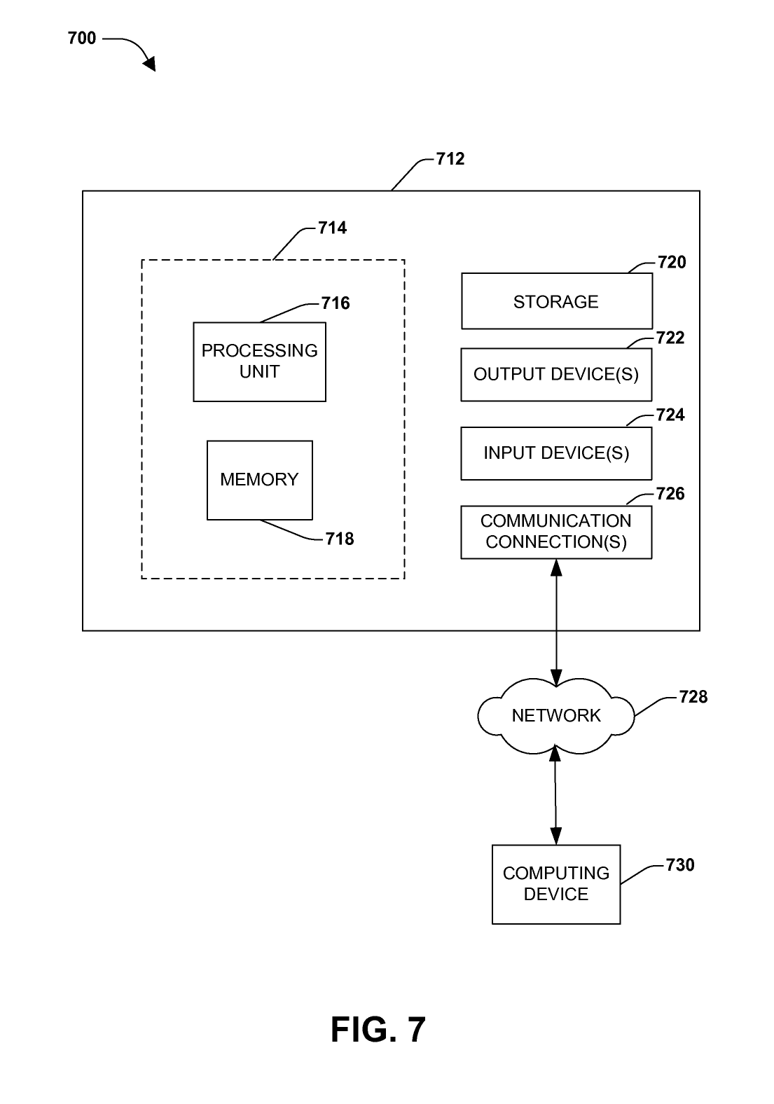

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for notifying a user of availability of a service on a user's first platform, comprising:
receiving a request to identify if the user of the first platform is associated with the service;
identifying whether the service is installed on the first platform, using a computer-based processor; and
responding with an indication that the service is available for installation on the first platform if the service is not installed on the first platform.

2. The method of claim 1, comprising receiving a request that is initiated by the user logging onto the first platform.

3. The method of claim 1, comprising receiving a request that is initiated by the user receiving an email from a domain associated with the service.

4. The method of claim 1, comprising receiving the request from one of:
an email service receiving an email from a domain associated with the service;
an online service store comprising the service, where the online service store is connected with the first platform; and
an application resident on the first platform that provides the service.

5. The method of claim 4, receiving the request from the email service comprising receiving the request from the email service to identify if a user is associated with the service on a second platform, comprising one or more of:
a device platform; and
a marketplace platform.

6. The method of claim 1, comprising registering the service as associated with one or more of:
a service application available for use on one or more platforms;
a service online domain; and
a service domain associated with one or more emails sent for the service.

7. The method of claim 6, comprising associating an identification (ID) for the service with an ID for the service application in respective one or more platforms.

8. The method of claim 7, identifying whether the service is installed on the first platform comprising using the service ID and service application ID to identify whether the service is installed on the first platform.

9. The method of claim 1, comprising associating the service with the first platform if the service is installed on the first platform after responding with an indication that the service is available for installation on the first platform.

10. The method of claim 1, receiving a request to identify if a user of a first platform is associated with the service comprising receiving a request from an online application store to identify if the user is associated with one or more of:
an application available through the application store;
a widget available through the application store; and
a website available through the application store.

11. The method of claim 10, comprising, responding with an indication that the service is available for installation on a second platform if the service is not installed on the second platform.

12. The method of claim 1, responding with an indication that the service is available for installation on the first platform comprising sending a response that initiates a notification to the user of the first platform of an availability of the service for use by the user on the first platform.

13. A system for notifying a user of availability of a service on a user's first platform, comprising:
a data storage component configured to store information about one or more services associated with a registered service provider;
an identification component, operably coupled with the data storage component, and configured to use the information on the data storage component to identify whether the service from the registered service provider is installed on the user's first platform; and
a request handling component, operably coupled with the identification component, and configured to:
receive a user ID request that comprises a request to identify if the user of the first platform is associated with the service; and
respond to the request with an indication that the service is available for installation on the first platform if the service is not installed on the first platform.

14. The system of claim 13, the first platform comprising one of:
a device platform; and
a marketplace platform.

15. The system of claim 13, comprising the service comprising one or more of:
an application associated with the registered service provider that has multi-platform functionality;
a website associated with the registered service provider; and
a widget that can be connected from a plurality of platforms.

16. The system of claim 13, comprising a service provider registration component configured to:
register a service provider with a service provider ID; and
register a service provider service with the service provider ID using a service ID for the platform associated with the service.

17. The system of claim 13, comprising an email notification component configured to:
identify a domain from which an email is sent to the user;
determine if the domain is associated with a registered service provider; and
identify the registered service provider associated with domain, if the domain is associated with the registered service provider.

18. The system of claim 13, comprising an application store notification component configured to:
determine if the user is associated with a service on a second platform;
identify a registered service provider associated with the service on the second platform, if the user is associated with a service on the second platform; and
indicate that the service is available for installation on the first platform if the user is associated with a service on the second platform, and the service is not installed on the first platform.

19. The system of claim 13, comprising an opt-out component configured to identify the user as opted-out of a service if an opt-out request is received by the opt-out component.

20. A computer-based method for notifying a user of availability of a service on a user's first platform, comprising:
registering the service as associated with one or more of:
a service application available for use on one or more platforms;
a service online domain; and
a service domain associated with one or more emails sent for the service;
associating an identification (ID) for the service with an ID for the service application in respective one or more platforms;
if the user of the first platform is associated with the service on the second platform, identifying whether the service is installed on the first platform, using a computer-based processor, comprising using the service ID and service application ID to identify whether the service is installed on the first platform; and
responding with an indication that the service is available for installation on the first platform if the service is not installed on the first platform, comprising sending a response that initiates a notification to the user of the first platform of an availability of the service for use by the user on the first platform.
